(19) United States
(12) Patent Application Publication
(10) Pub. No.: US 2014/0056776 A1
(43) Pub. Date: Feb. 27, 2014

(54) DEVICE FOR SEPARATING OVERSPRAY OF A LIQUID COATING MATERIAL

(71) Applicants: Hans-Georg FRITZ, Ostfildern (DE); Jens HOLZHEIMER, Tamm (DE); Dietmar WIELAND, Waiblingen (DE)

(72) Inventors: Hans-Georg FRITZ, Ostfildern (DE); Jens HOLZHEIMER, Tamm (DE); Dietmar WIELAND, Waiblingen (DE)

(73) Assignee: Dürr Systems GmbH, Bietigheim-Bissingen (DE)

(21) Appl. No.: 13/973,388

(22) Filed: Aug. 22, 2013

Related U.S. Application Data
(62) Division of application No. 12/674,938, filed on Feb. 24, 2010, now abandoned.

(30) Foreign Application Priority Data
Aug. 24, 2007 (DE) 102007040153.3-51

(51) Int. Cl. B05B 15/00

(52) U.S. Cl. CPC B05B 15/008
USPC 422/187

(57) ABSTRACT

A device for separating overspray of a liquid coating material from a gas flow flowing through an application region of a system for coating workpieces comprises a separating device comprising several regenerable surface filters which are arranged on two mutually opposite vertical sidewalls of a flow chamber, are spaced apart from one another in a workpiece conveying direction and protrude with filter elements into a lower portion of the flow chamber, the overspray which has passed into said gas flow in the application region being charged in said separating device with at least one auxiliary agent introduced into the gas flow. A barrier layer is thereby formed to reduce filter surface clogging. A fluid which reacts chemically with the overspray is provided at least in part as the auxiliary agent for bonding the overspray.

### CROSS-REFERENCE TO RELATED APPLICATIONS

This application is a divisional application of U.S. patent application Ser. No. 12/674,938, filed Feb. 24, 2010 which is a National Phase application claiming the benefit of International Application PCT/EP2008/005954, filed Jul. 21, 2008, which claims priority to German Patent Application No. DE 10 2007 040 153.3-51 filed Aug. 24, 2007, the complete disclosures of which are hereby incorporated in by reference in their entireties.

### BACKGROUND

The present disclosure relates to a method and a device for separating overspray of a liquid coating material from an air or gas flow flowing through an application region of a system for coating workpieces. This relates, for example, to a system for the automatic painting of vehicle bodies or parts thereof, e.g., using painting robots.

Methods and devices of this generic type are generally known, for example as described by WO 2007/039276 A1 and WO 2007/039275 A1 as well as from DE 10 2005 013 708 A1, DE 10 2005 013 709 A1, DE 10 2005 013 710 A1 and DE 10 2005 013 711 A1, each of which are hereby expressly incorporated by reference in their entireties. In accordance with these systems, the dry separation of the wet paint overspray from the exhaust air stream from the spray booth is effected in a filter device after a flowable, particulate, so-called pre-coat material has been previously dispensed into the exhaust air stream by means of a nozzle arrangement. The purpose of the pre-coat material in these examples is for it to be deposited as a barrier layer on the filter surfaces in order to prevent these surfaces from clogging due to adhering overspray particles, “detackifying” properties of these particles are based predominantly on a small size and the resulting large specific surface and on the surface structure. For example, lime, rock meal, aluminium silicates, aluminium oxides, silicon oxides, powder paint or the like are used as pre-coat material which is separated in the filter device with the overspray. By periodically cleaning the filter device, the mixture consisting of pre-coat material and wet paint overspray enters into reception containers, from where it can be partly directed to a renewed use as a pre-coat material. However, in the case of an excessively high paint concentration, the mixture must be removed from the painting system and typically must be disposed of, i.e. incinerated or land-filled, as household waste. This disposal is not practical owing to the constituents which are valuable per se.

Another method of the generic type mentioned above is generally disclosed by DE 4211465 C2 which is used for the dry separation, recovery and processing of a mist incident in spray painting operations and consisting of sticky paint particles from the exhaust air stream. This method involves the addition of a paint-compatible auxiliary dusty substance geared towards the recovery of the separated mist. For the purposes of recovery, one part of the recovered auxiliary dusty substance is reintroduced into the circuit through the booth whilst the other part is discharged for processing this proportion to form new paint with the addition of fresh paint raw materials and/or solvents, and is supplemented by a fresh auxiliary dusty substance. Colour pigments or inorganic filler materials are to be used as paint-compatible auxiliary dusty substances.

Accordingly, there is a need for a method and a corresponding device having an auxiliary material which permits improved bonding of the overspray than previously the case and can also be adapted more effectively to the requirements of an automatic coating system.

### BRIEF DESCRIPTION OF THE DRAWINGS

The present disclosure will be further explained using the exemplary illustrations shown in the drawing. In the drawing:

FIG. 1 shows a schematic perspective illustration of an exemplary coating system;

FIG. 2 shows a schematic vertical sectional view of an exemplary pre-coat feed container; and

FIG. 3 shows a schematic view of an exemplary injector for pre-coat material in the feed container of FIG. 2.

### DETAILED DESCRIPTION

In order to improve the absorption capacity of an auxiliary agent or pre-coat material for overspray, it is possible to use substances which are specifically processed or which are produced by means of specific processes. For example, particles having a large inner surface such as, e.g. zeolites, i. e. natural or synthetically produced hydrated aluminosilicates can be used. On account of their hollow space structure having numerous pores and channels, they have a relatively large inner surface which has an extraordinarily high and specific ion exchange, adsorption and hydration capability (1 gram of zeolite can have a surface area of up to 1000 m²).

Commercially available hollow balls consisting of polymers, glass or aluminium silicate etc. can also be used, e.g., with inner spaces which are accessible to paint particles from the outside, in order to permit an improvement in absorption.

For the same purpose, it is also possible to use fibres from different materials of natural origin, such as e.g. cotton, cellulose, wollastonite, attapulgite and sepiolite or from synthetic production such as glass, ceramic, gypsum, carbon or polymer fibres or the like.

Paint particles are absorbed effectively into the pre-coat particles due to the fibre and/or hollow space structure of such substances having inner and/or outer surfaces which are large in relation to their outer dimensions.

As an alternative or in addition to particles, it is also possible in accordance with the exemplary illustrations to use liquid or gaseous fluids as auxiliary agents or additives.

In specific cases, it can be purposeful or even necessary to bond the overspray not or not only physically but chemically, e.g., on the surface of the pre-coat material. Either the pre-coat material has reactive groups for this such as, for example, amine, epoxy, carboxyl, hydroxyl or isocyanate groups, or substances which have these groups on their surface are added to the pre-coat material. These substances can be, e.g., solid or liquid monomers, oligomers or polymers or silanes, silanols or siloxanes, with the proviso that the substances used in accordance with the exemplary illustrations should generally not cause any paint flaws. Another example of a usable, chemically reactive substance is a commercially available (under the designation AEROXIDE Alu C 805) aluminium oxide which is post-treated with octylsilane. All substances stated here can be used individually or as a mixture of different substances. Two or more different components may advantageously be employed, with which, in addition to the ability to bond and/or absorb paint particles, an optimisation of important process properties, such as e.g. the delivery properties including fluidisation capability and flowability, is achieved. Additives to be used for the purpose of improving the flowability and fluidisation capability may be, for example, fine-particle aluminium oxide or fine-particle or highly dispersed (pyrogenic) silicic acids. Owing to their large specific surface areas, these substances can simultaneously improve the absorption of the auxiliary material.

Additives which themselves are not volatile and do not result in harmful volatile substances owing to an undesired chemical reaction with the auxiliary material or the paint may be advantageous.

Liquid or gaseous substances or fluids can be sprayed as an addition to particulate or dusty pre-coat material, for example by means of nozzles into the air or other gas flow acting upon the overspray and/or into the pre-coat material. For example, the fluid can be sprayed by means of dispersion nozzles which can be located on specific receiving containers, into which the particulate pre-coat material is conveyed, as described in PCT/EP2008/005961 and DE 10 2007 040 154.1, each of which are hereby expressly incorporated by reference in their entireties.

A purposeful example of a liquid suitable as an addition to the particulate pre-coat material is a hydrolysed amine such as NH₄OH as a result of an aqueous solution of NH₃. Upon reaction of a hydrolysed amine with an ester (saponification), reactive amine salts of the acid corresponding to the respective ester are obtained. More generally, liquids which contain reactive molecules or substances, i.e. also solutions of salts or soluble substances, can be suitable for use in the exemplary illustrations. The amine reacts in particular in a chemical manner with some paint components and is intended to remove the tackiness from the mixture consisting of overspray and pre-coat material. The lower the tackiness of the mixture the better it can be fluidised, dispersed and transported (away), and the higher the proportion of paint overspray in the pre-coat material can be before it has to be discarded and replaced by fresh material, thus resulting in a smaller waste quantity, if the discarded pre-coat material is not to be recycled for other purposes. The e.g. amine-containing liquid may be injected in the filter region into the fluidised pre-coat material, e.g. by the aforementioned, in certain cases already present dispersion nozzles on the reception containers of the pre-coat material.

A gaseous auxiliary agent which can also be used in addition to the particulate pre-coat material includes e.g. ammonia (NH₃) or other gases in particular with reactive groups or, more general, molecules with reactive groups which are volatile at least at temperatures from 20° C. It is feasible to synthesize short-chain, volatile substances or oligomers which can contain the reactive groups mentioned here and further above.

Substances which are to be added to the auxiliary material in accordance with the exemplary illustrations may also include the pre-coat particles, which are used in the case of the known methods mentioned above, including powder paint.

The addition of the described additives or loading materials can be effected in a separate process, i.e. with delivery of the ready-made mixture to the system operator, or it can be effected during the painting process. The addition during the painting process can be effected in specific cases in dependence upon the accumulating quantity of overspray.

In general, the substances to be used in the exemplary illustrations can be selected purposefully for adaptation to the paint material used in the system in each case.

Using a suitable mixture can substantially increase the ability of the auxiliary material to absorb paint, thus resulting in lower operating costs and a process which is less sensitive to disruptions. Furthermore, a substantial advantage of the exemplary illustrations can be seen in the fact that by mixing several components, the auxiliary material can be adapted to the intended purpose and to the requirements of an automatic coating system in an optimum manner and substantially more effectively than by using individual pure raw materials as in the case of the known methods described above.

As in the case of the known methods, the auxiliary agent can be partially recycled in the coating system after use. However, in accordance with another aspect of the exemplary illustrations which is likewise important for the optimisation of the operation of coating systems, it can also be purposeful to select the substances of the auxiliary material in such a manner that after use in the coating system they do not have to be disposed of in a useless and costly manner, but instead can be utilised for purposes other than the coating of workpieces. An example of this is the use of the auxiliary material in accordance with the exemplary illustrations as an insulating material. A particular practical and typical other example is a thermal utilisation in the brick or cement industry or the like, where the inorganic component present e.g. as an additive or loading material goes into the desired product, while at the same time the paint proportion can be used as an energy carrier in a combustion procedure required for the production.

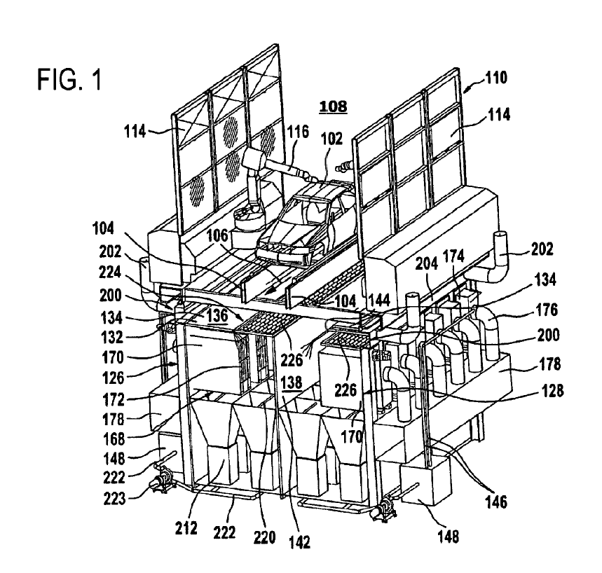

An exemplary painting system for vehicle bodies 102 as illustrated in FIG. 1 generally comprises a conveying device 104, by means of which the vehicle bodies 102 can be moved in a conveying direction 106 through the application region 108 of a painting booth which is designated in its entirety by the reference numeral 110. The application region 108 is the inner space of the painting booth 110 which is defined in its horizontal transverse direction, which extends generally perpendicularly with respect to the conveying direction 106, i.e. with respect to the longitudinal direction of the painting booth 110, on both sides of the conveying device 104 by means of a respective booth wall 114. On both sides of the conveying device 104, painting machines 116, e.g. in the form of painting robots, are arranged in the painting booth 110.

A circulating air circuit (not illustrated) serves to generate an air stream which passes through the application region 108 substantially vertically from the top downwards. In the application region 108, this air stream absorbs paint overspray in the form of overspray particles. The term “particle” comprises both solid and also liquid particles, in particular droplets. When using wet paint, the wet paint overspray generally consists of paint droplets. Most of the overspray particles have a maximum dimension in the range of about 1 μm to about 100 μm.

The exhaust air stream leaves the painting booth 110 downwards and passes into a device, which is designated in its entirety by the reference numeral 126, for separating wet paint overspray from the exhaust air stream, said device being arranged below the application region 108. The device 126 comprises a substantially cubical flow chamber 128 which extends in the conveying direction 106 over the entire length of the painting booth 110 and is defined in the transverse direction of the painting booth by means of vertical sidewalls which are aligned substantially with the lateral booth walls 114 of the painting booth 110, so that the flow chamber 128 has substantially the same horizontal cross-sectional surface as the painting booth 110 and is arranged substantially completely within the vertical projection of the base surface of the painting booth 110. The flow chamber 128 is divided into an upper portion 136 and a lower portion 138 by means of flow conducting elements 132 which in this exemplified embodiment are formed as a substantially horizontally aligned flow conducting surface 134. The portions 136 and 138 are connected to each other by a constriction point which is in the form of a gap between the mutually opposite free edges of the flow conducting elements 132 and forms a constriction in the flow path of the exhaust air stream through the flow chamber 128. The horizontal cross-sectional surface of the constriction point is about 35% to about 50% of the horizontal cross-sectional surface of the flow chamber 128 at the height of the constriction point. The air speed of the exhaust air stream in the region of the constriction point can be, for example, between about 0.6 m/s and about 2 m/s. The lower portion 138 of the flow chamber 128 may be divided into two partial portions by means of a vertical partition wall 142 which extends in parallel with the conveying direction 106.

In each case a pre-coat feeding device 144 in the form of a pre-coating lance which extends in the conveying direction 106 may be integrated into the constriction point-side edge of each of the flow conducting elements 132. Each of the pre-coating lances can have a diameter of, e.g., about 30 mm and can be provided with a plurality of atomiser nozzles which can be arranged at a spaced interval of about 50 mm to about 100 mm in the longitudinal direction of the pre-coating lance and can have an opening size in the range of about 3 mm to about 15 mm. These atomiser nozzles of the pre-coating lances dispense, e.g. at intervals, a pre-coat material in the form of an atomised spray into the exhaust air stream.

The pre-coat feeding devices 144 may be connected in each case via one or several pre-coat feeding lines 146 to a respective pre-coat feed container 148, in which the pre-coat material is stored in a flowable state (fluidised). The pre-coat material can consist of particles which can have, e.g., an average diameter in the range of about 10 μm to about 100 μm, but can also be larger or smaller.

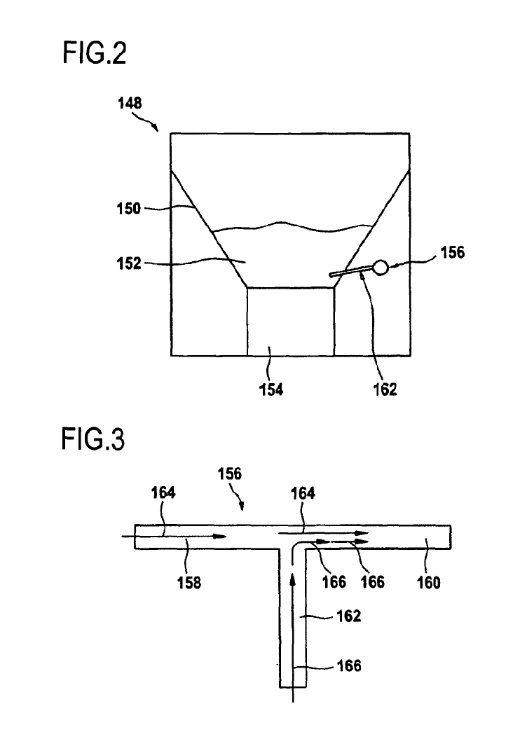

The construction of an exemplary pre-coat feed container 148 is illustrated in detail in FIG. 2. Located in the interior of the feed container 148 is a storage chamber 150 which tapers downwards in the manner of a funnel and contains a fluid bed 152 consisting of flowable pre-coat material which is disposed above a compressed air chamber 154. The pre-coat material may be delivered from the storage chamber 150 by means of an injector 156 which is illustrated in detail in FIG. 3. The injector 156 is in the shape of a T-piece having a compressed air connection 158, a connection 160 for a pre-coat feeding line 146 and having a piercing lance 162 which protrudes into the fluid bed 152 in the storage chamber 150. In order to convey pre-coat material, the injector 156 has compressed air (under a pressure of e.g. about 5 bar) passing through it from its compressed air connection 158 towards the connection 160 for the pre-coat feeding line 146, as indicated by the arrows 164 in FIG. 3. This flow of compressed air generally produces a suction effect, on account of which the fluidised pre-coat material is sucked from the fluid bed 152 through the piercing lance 162 into the injector 156 and passes through the connection 160 into the pre-coat feeding line 146. The pre-coat flow through the injector 156 is indicated by the arrows 166 in FIG. 3.

Turning back to FIG. 1, a respective separating device 168 for separating the wet paint overspray from the exhaust air stream may be provided on both sides of the constriction points in the partial portions of the lower portion 138 of the flow chamber 128. The separating devices 168 comprise in each case several regenerable surface filters 170 which are arranged on the two mutually opposite vertical sidewalls of the flow chamber 128, are spaced apart from one another in the conveying direction 106 and protrude with their filter elements 172 into the lower portion 138 of the flow chamber 128. Each of the regenerable surface filters 170 comprises a hollow basic body, on which several, e.g. substantially plate-shaped filter elements 172 are held. The filter elements 172 can be, e.g., plates consisting of sintered polyethylene which are provided on their outer surface with a membrane consisting of polytetrafluoroethylene (PTFE). The coating consisting of PTFE serves to elevate the filter class of the surface filter 170, i.e. reduce its permeability, and is also intended to prevent the permanent adhesion of the wet paint overspray separated from the exhaust air stream. Both the basic material of the filter elements 172 and also the PTFE coating thereof have a porosity, so that the exhaust air can pass through the pores into the inner space of the respective filter element 172.

In order to prevent the filter surfaces from clogging, they may also be provided with a barrier layer consisting of pre-coat material discharged into the exhaust air stream. During operation of the device 126, this barrier layer forms by the separation of the pre-coat material, which is discharged into the exhaust air stream, on the filter surfaces and prevents the filter surfaces from clogging due to adhesive wet paint overspray. Pre-coat material from the exhaust air stream also deposits on the boundary walls of the lower portion 138 of the flow chamber 128, where it also prevents adhesion of wet paint overspray.

The exhaust air stream generally passes over the surfaces of the filter elements 172 of the regenerable surface filters 170, wherein both the entrained pre-coat material and also the entrained wet paint overspray are separated on the filter surfaces, and said exhaust air stream passes through the porous filter surfaces into the inner spaces of the filter elements 172 which are connected to a hollow space inside a basic body 174 of the respective surface filter 170. The cleaned exhaust air stream thus passes through the basic body 174 in each case into an exhaust air pipe 176 which leads from the respective regenerable surface filter 170 to an exhaust air channel 178 which extends laterally next to a vertical sidewall of the flow chamber 128 and in parallel with the conveying direction 106. The exhaust air, which has been cleansed of the wet paint overspray, from the two exhaust air channels 178 passes through an exhaust air collector line to a circulating air fan (not illustrated), from where the cleansed exhaust air is fed via a cooling battery to an air chamber, the so-called plenum, which is arranged above the application region 108. From this location the cleansed exhaust air returns via a filter cover to the application region 108. A part of the exhaust air stream which is discharged to the environment may be replaced by fresh air which is fed to a supply air system via a fresh air feeding line. The fresh air is fed into the flow chamber 128 via two air curtain generation devices 200 which are connected to the supply air system in each case via a supply air line 202 and in each case have a supply air chamber 204 which extends along the conveying direction 106 and which is supplied with supply air via the supply air lines 202. The supply air system comprises a cooling battery (not illustrated), with which the air fed in the air curtain generation devices 200 is cooled such that it is colder than the exhaust air stream exiting the application region, which ensures that the air fed via the air curtain generation device 200 falls downwards in the flow chamber 128, i.e. towards the surfaces of the flow conducting elements 132 which are to be protected. As this cooled supply air flows further through the lower portion 138 of the flow chamber 128, through the exhaust air channels 178 and through the exhaust air collector line, this cooled supply air mixes with the exhaust air stream from the application region 108, so that the heating of the cleansed exhaust air which once again is fed via the feeding line to the application region is partly compensated for by the circulating air fan. Most of the air guided through the application region 108 is thus guided in a circulation circuit which comprises the application region 108, the flow chamber 128, the exhaust air channels 178, the exhaust air collector line, the circulating air fan, the feeding line and the air chamber above the application region 108, wherein continuous heating of the air guided in the circulating air circuit is avoided.

Since the wet paint overspray is separated from the exhaust air stream 120 by means of the surface filters 170 in a dry manner, i.e. without any washing out with a cleansing liquid, the air guided in the circulating air circuit is not humidified when the wet paint overspray is separated, so that no devices whatsoever are required for the dehumidification of the air guided in the circulating air circuit. Furthermore, no devices are required for separating wet paint overspray from a washing out-cleansing liquid.

The regenerable surface filters 170 can be cleaned by compressed air pulses in specific time intervals, when their loading with wet paint overspray has reached a specified extent. After cleaning, a new barrier layer may be produced on the filter surfaces by the addition of pre-coat material into the exhaust air stream by means of the pre-coat feeding devices 144, wherein the barrier layer can consist of 100% wet paint-free pre-coat material or of wet paint-loaded pre-coat material.

The wet paint-containing material which is cleaned off from the filter surfaces of the filters 170 may pass into pre-coat reception containers 212, of which several are arranged in the lower portion 138 of the flow chamber 128 such that their upwardly turned mouth openings cover substantially the entire horizontal cross-section of the flow chamber 128. This ensures that the entire material cleaned off from the surface filters 170 and the pre-coat and overspray material which is separated from the exhaust air stream even prior to reaching the surface filters 170 passes through the mouth openings into the pre-coat reception containers 212. Each of the pre-coat reception containers can have an upper part, which tapers downwards in the manner of a funnel, and a substantially cubical lower part. In proximity to the upper mouth opening, each upper part of a pre-coat reception container 212 may be provided with a compressed air lance 220 which crosses the upper part and by means of which the material located in the upper part can be charged with a pulse of compressed air and thus dispersed.

The dispersed material can pass upwards through the mouth opening and can deposit, e.g., on the filter surfaces of the surface filters 170 or on the vertical partition wall 142 which is protected by the coating of pre-coat material to prevent adhesion of the wet-paint overspray from the exhaust air stream.

From the lower parts of the pre-coat reception containers 212, the material contained therein, i.e. a mixture of pre-coat material and wet paint overspray, can be conveyed by a respective suction line 222, in which a pre-coat suction pump 223 is arranged, in each case into one of the pre-coat feed containers 148, in order to be directed from this location in the manner described through the pre-coat feeding line 146 to renewed usage as pre-coat material.

In addition to the pre-coat feed containers 148, from which wet paint-loaded pre-coat material is fed to the feeding line 146, the device 126 can also comprise further pre-coat feed containers which are not connected to the reception containers 212, but rather are filled with wet paint-free pre-coat material, in order optionally to feed wet paint-free pre-coat material to the pre-coat feeding line 146. This intermediate pre-coating of the surface filters 170 and the vertical partition wall 142 can be performed in time intervals of, e.g., about 15 min to about 1 hour. In order to ensure that pre-coat material does not pass through the constriction point into the application region 108 or wet paint overspray does not pass through the constriction point to the surface filters 170 during these intermediate pre-coating procedures or during the cleaning procedure and the subsequent pre-coating of the surface filters 170, the constriction point may be closed during these procedures by means of closure devices 226.

The above-described exemplary illustrations can be modified in various aspects. Merely as an example, it is possible to use a simple fluidising container instead of the feed container 148, which operates with the injector 156, i.e. like a pump, and to convey the fluidised auxiliary material by means of a pump connected downstream. Pumps which are suitable for this purpose and in particular meter substances pursuant to the dense flow and suction/pressure principle are known, e.g. from EP 1 427 536 B1, WO 2004/087331 A1 or FIG. 3 of DE 101 30 173 A1. Instead, a so-called blow pot can also be used as a feed container, as known in principle e.g. from JP 02123025 A or JP 06278868 A.

The possibility also exists for introducing the pre-coat material into the air flow containing the overspray particles in a different manner than with the above-described device 144. In particular, it may be advantageous to initially convey the fresh auxiliary material, prior to charging the overspray, into reception containers which are distributed below the application region 108 in a manner similar to the containers 212 and from where the auxiliary material then passes into the air flow, as described in PCT/EP2008/005961 and DE 10 2007 040 154.1.

The invention is not limited to the previously described exemplary embodiment. Rather, a multiplicity of variants and variations are possible, which likewise make use of the inventive idea and therefore come under the protective scope.exemplary illustrations are not limited to the specific examples described above. Rather, a plurality of variants and modifications are possible, which likewise make use of the concepts of the exemplary illustrations and therefore fall under the scope of protection. Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be evident upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “the,” etc. should be read to recite one or more of the indicated elements unless a claim recites an explicit limitation to the contrary.

1-25. (canceled)

26. A device for separating overspray of a liquid coating material from a gas flow flowing through an application region of a system for coating workpieces, comprising:
a separating device comprising several regenerable surface filters which are arranged on two mutually opposite vertical sidewalls of a flow chamber, are spaced apart from one another in a workpiece conveying direction and protrude with filter elements into a lower portion of the flow chamber, the overspray which has passed into said gas flow in the application region being charged in said separating device with at least one auxiliary agent introduced into the gas flow, whereby a barrier layer is formed to reduce filter surface clogging, wherein a fluid which reacts chemically with the overspray is provided at least in part as the auxiliary agent for bonding the overspray.

27. The device according to claim 26, wherein paint-loaded material cleaned from filter surfaces of said filters passes into auxiliary agent reception containers, the material contained in the reception containers being conveyed from lower parts of the reception containers by a respective suction line, in which an auxiliary agent suction pump is arranged, into a respective auxiliary agent feed container, the paint-loaded material further being directed from the auxiliary agent feed container through an auxiliary agent feeding line to renewed usage as auxiliary agent.

28. The device according to claim 27, wherein the flow chamber is divided into an upper portion and a lower portion by substantially horizontally aligned flow conducting elements, said upper and lower portions being connected to each other by a constriction point.

29. The device according to claim 26, wherein the flow chamber is divided into an upper portion and a lower portion by substantially horizontally aligned flow conducting elements, said upper and lower portions being connected to each other by a constriction point.

30. The device according to claim 26, wherein at least one of a paint-loaded auxiliary agent material and a paint-free auxiliary agent material is supplied for forming said barrier layer.

31. The device according to claim 26, wherein the separating device contains at least one filter element configured to receive the gas flow.

32. The device according to claim 26, wherein the separating device is configured to provide a mixture of at least two different substances as the auxiliary agent.

33. The device according to claim 26, wherein the separating device is configured to provide chemically reactive liquid or particles selected from the group consisting of amine, epoxy, carboxyl, hydroxyl and isocyanate groups.

34. The device according to claim 26, wherein the separating device is configured to provide one of a solid monomer, a liquid monomer, an oligomer, a polymers, a silane, a silanol, and a siloxane as the auxiliary agent.

35. The device according to claim 26, wherein the separating device is configured to provide an additive configured to improve a fluidisation capability of the auxiliary material to the auxiliary material.

36. The device according to claim 26, further comprising at least one nozzle configured to add at least one chemically reactive fluid to the gas flow.
